(19) United States
(12) Patent Application Publication
(10) Pub. No.: US 2014/0004935 A1
(43) Pub. Date: Jan. 2, 2014

(54) GAME SYSTEM, AND CONTROL METHOD AND COMPUTER READABLE MEDIUM THEREFOR

(71) Applicants: Yoshiaki TEZUKA, Minato-ku (JP); Yoshihiro FUJIKAWA, Minato-ku (JP); Yukito HIROSE, Minato-ku (JP); Tatsuru TAKAHASHI, Minato-ku (JP)

(72) Inventors: Yoshiaki TEZUKA, Minato-ku (JP); Yoshihiro FUJIKAWA, Minato-ku (JP); Yukito HIROSE, Minato-ku (JP); Tatsuru TAKAHASHI, Minato-ku (JP)

(21) Appl. No.: 13/763,329

(22) Filed: Feb. 8, 2013

(30) Foreign Application Priority Data
Jun. 29, 2012 (JP) 2012-147561

(51) Int. Cl. G06F 21/31

(52) U.S. Cl. CPC G06F 21/31
USPC 463/29

(57) ABSTRACT

A game system that provides a game played by plural players, presents one user an item within items owned by another user, the item being capable of been synthesized with an item owned by the one user, and allows the user to select an item desired by the user to be synthesized and accepts that. The game system notifies another user owning the item selected by the one user that there is an application for synthesis from the one user, and inquiries about whether to allow the synthesis. The game system generates and presents a new item to the one user on the condition that the another user allows the synthesis in response to the inquiry.

### CROSS REFERENCE TO RELATED APPLICATION

This application claims priority to Japanese Patent Application No. 2012-147561, filed Jun. 29, 2012, the disclosure of which is hereby incorporated by reference in its entirety.

### TECHNICAL FIELD

The present invention relates to a game system enabling a user to generate a new item in a game by synthesizing a plurality of items, and a control method and a computer readable medium which are used for the game system.

### BACKGROUND ART

There has been known a game apparatus where a user owns some items in a game and uses the items to play the game. Further, in such a game apparatus, it has been known that a user can generate a new item by synthesizing two or more types of items from the items owned by the user (see, for example, Patent Literature 1).
Patent Literature 1: JP 2007-111319 A.

### SUMMARY OF INVENTION

### Technical Problem

In a game described in Patent Literature 1, in order to synthesize items into a new item, a user's character managed by one user needs to own all items being materials for the new item. There has been known a network game in which a plurality of users can participate in the game. Further, in such a network game, there has been known a game that has a function capable of obtaining a new item by synthesizing a plurality of items to be raw materials as described above. In a game in which a plurality of users participate, there may be a case where one user owns a part of a plurality of items to be raw materials which are synthesized to generate a new item, and other users own the remaining part of the items. In a game system as described in Patent Literature 1, even in such a case, one user cannot generate a new item because the user cannot synthesize items to be raw materials if the user does not own all of the items to be raw materials.

Therefore, an object of the present invention is to provide a game system enabling a user to generate a new item by synthesizing items using an item owned by another user, and a control method and a computer readable medium which are used for the game system.

### Solution to Problem

A game system as one aspect of the present invention is a game system that provides a game played by a plurality of users and enables each user to play the game by using items owned by the user in the game and to generate a new item by synchronizing a plurality of items including the items owned by the user, comprising: a presenting unit which is adapted and configured to present one user within the plurality of users, at least one item within items owned by another user different from the one user, the at least one item being capable of been synthesized with an item owned by the one user; an accepting unit which is adapted and configured to allow the one user to select a first item which is an item desired by the one user to be synthesized within the items owned by the one user, and a second item which is, within the at least one item presented by the presenting unit, an item desired by the one user to be synthesized with the first item, and accept an input of selection; an inquiring unit which is adapted and configured to, when the accepting unit accepts the input of selection with respect to the first item and the second item, notify a user owning the second item that there is an application for synthesis which uses the second item from the one user, and make an inquiry about whether to allow the synthesis; and an item providing unit which is adapted and configured to generate a new item based on the first item and the second item, on the condition that the user owning the second item allows use of the second item for the synthesis in response to the inquiry by the inquiring unit, and provide the new item to the one user. Thereby, the game system solves the above problems.

According to the game system of the present invention, when synthesizing items, a user can generate a new item by using an item owned by another user. Therefore, it is possible to increase the number of items selectable as the second item, so that a variation in the new item to be generated by the synthesis can be increased. Further, the new item is generated only when the user owning the second item allows that the second item is used for the synthesis. That is, the generation of the new item is performed depending on intention of each user. Therefore, the user owning the second item may decline the synthesis.

In an embodiment of the game system of the present invention, the item providing unit may be adapted and configured to further provide the new item to the user owning the second item. In this case, the user owning the second item can also obtain a privilege by providing the second item.

In an embodiment of the game system of the present invention, each of the items in the game may have its own information, and the item providing unit may be adapted and configured to generate the new item so that information of the new item include at least one part of information of the first item and information of the second item. In this case, it can be seen as if the new item has been generated from the first item and the second item.

In an embodiment of the game system of the present invention, the item providing unit may be adapted and configured to, after presenting the new item to the one user, allow the one user to own the first item with a restriction so as not to use the first item for generating another new item, and the game system may further include a restriction removing unit which is adapted and configured to remove, in a case that the new item is deleted from the game, the restriction given by the item providing unit so that the first item is available to generate another new item. In this case, by deleting the new item generated by the synthesis, even though the item used once for the synthesis, it is possible to use the item for synthesis again and again. Therefore, the user can generate various kinds of new items by using the same item. Accordingly, since the user does not need to own a plurality of same types of items, it is possible to reduce a burden on the user.

A control method as one aspect of the present invention is a control method for controlling a computer incorporated into a game system that provides a game played by a plurality of users and enables each user to play the game by using items owned by the user in the game and to generate a new item by synchronizing a plurality of items including the items owned by the user, the control method making the computer execute the steps including: a presenting step of presenting one user within the plurality of users, at least one item within items owned by another user different from the one user, the at least one item being capable of been synthesized with an item owned by the one user; an accepting step of allowing the one user to select a first item which is an item desired by the one user to be synthesized within the items owned by the one user, and a second item which is, within the at least one item presented by the presenting step, an item desired by the one user to be synthesized with the first item, and accepting an input of selection; an inquiring step of, when the input of selection with respect to the first item and the second item being accepted by the accepting step, notifying a user owning the second item that there is an application for synthesis which uses the second item from the one use, and making an inquiry about whether to allow the synthesis; and an item providing step of generating a new item based on the first item and the second item, on the condition that the user owning the second item allows use of the second item for the synthesis in response to the inquiry by the inquiring step, and providing the new item to the one user.

A non-transitory computer readable medium as one aspect of the present invention is a non-transitory computer readable medium storing a computer program for a game system that provides a game played by a plurality of users and enables each user to play the game by using items owned by the user in the game and to generate a new item by synchronizing a plurality of items including the items owned by the user, the computer program making a computer incorporated into the game system function as: a presenting unit which is adapted and configured to present one user within the plurality of users, at least one item within items owned by another user different from the one user, the at least one item being capable of been synthesized with an item owned by the one user; an accepting unit which is adapted and configured to allow the one user to select a first item which is an item desired by the one user to be synthesized within the items owned by the one user, and a second item which is, within the at least one item presented by the presenting unit, an item desired by the one user to be synthesized with the first item, and accept an input of selection; an inquiring unit which is adapted and configured to, when the accepting unit accepts the input of selection with respect to the first item and the second item, notify a user owning the second item that there is an application for synthesis which uses the second item from the one use, and make an inquiry about whether to allow the synthesis; and an item providing unit which is adapted and configured to generate a new item based on the first item and the second item, on the condition that the user owning the second item allows use of the second item for the synthesis in response to the inquiry by the inquiring unit, and provide the new item to the one user. By executing the control method or the computer program of the present invention, it is possible to realize the game system of the present invention.

### Advantageous Effects of Invention

As described above, according to the present invention, when synthesizing items, a user can generate a new item by using an item owned by another user. Therefore, the number of items selectable as the second item can be increased, so that a variation in the new item generated by the synthesis can be increased. Further, in the present invention, since generation of the new item is performed depending on intention of each user, the user owning the second item may decline the synthesis.

### BRIEF DESCRIPTION OF DRAWINGS

FIG. 1 is a diagram illustrating an outline of an overall configuration of a game system according to an embodiment of the present invention;

FIG. 2 is a functional block diagram of a main section of the game system;

FIG. 3 is a diagram illustrating an example of a game screen displayed on a monitor of a user terminal apparatus;

FIG. 4 is a diagram illustrating a front surface of a card;

FIG. 5 is a diagram illustrating a back surface of the card;

FIG. 6 is a flow chart of a breeding processing routine executed in the game system;

FIG. 7 is a diagram illustrating an example of a game screen in a state of displaying a list of breeding horses; and

FIG. 8 is a diagram illustrating an example of a game screen in a state of displaying a new racehorse.

### DESCRIPTION OF EMBODIMENTS

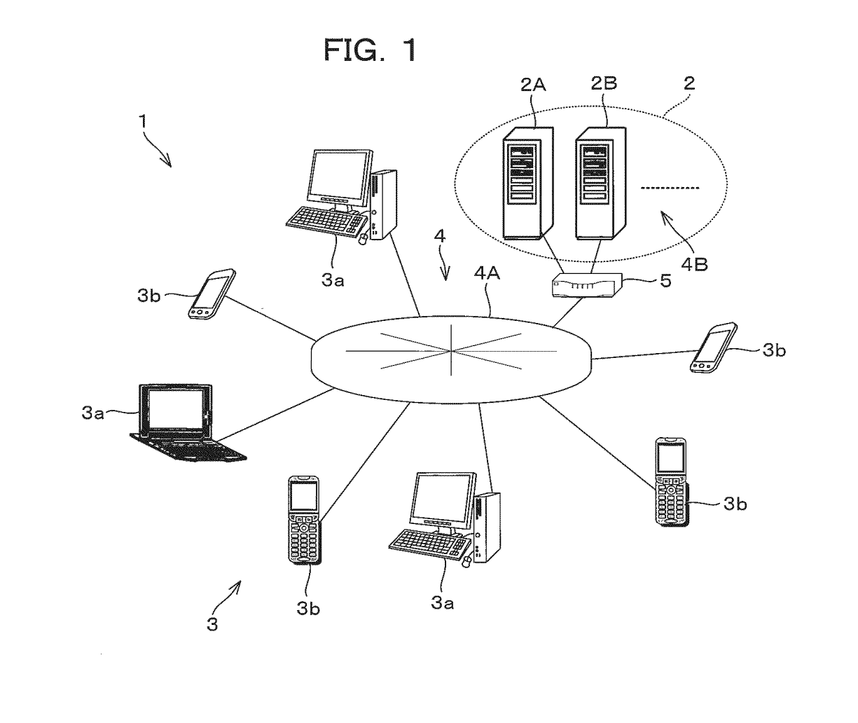

A game system according to an embodiment of the present invention will be described with reference to FIGS. 1 to 8. The game system 1 provides a user with a so-called racehorse training game in which the user owns a plurality of racehorses in the game and gets the racehorses to participate in a race or to breed. FIG. 1 is a diagram illustrating an outline of an overall configuration of the game system according to an embodiment of the present invention. As illustrated in FIG. 1, the game system 1 includes a center server 2 as a server apparatus, and a user terminal apparatus 3 as a client apparatus connectable to the center server 2 through a predetermined network 4. The center server 2 is configured as one logical server apparatus by combination of a plurality of server units 2A, 2B, . . . . However, the center server 2 may be configured as a single server unit. Alternatively, the center server 2 may be configured logically using the cloud computing.

The user terminal apparatus 3 is a computer apparatus that is capable of network connection and is used personally by a user. For example, a stationary or book-type personal computer (hereinafter, referred to as a PC) 3a or a mobile terminal apparatus 3b such as a portable phone or a smart phone, is used as the user terminal apparatus 3. In addition, various types of computer apparatuses that are capable of network connection and plus, are used personally by users, such as stationary home game machines, portable game machines, and portable tablet terminal apparatuses, may be used as the user terminal apparatus 3.

The center server 2 and the user terminal apparatus 3 are communicatively connected to each other through the network 4. The network 4 includes a WAN (Wide Area Network) 4A, and a LAN (Local Area Network) 4B that contains the server units 2A, 2B, . . . of the center server 2 and connects the server units 2A, 2B, . . . to each other. The WAN 4A to be used includes, for example, the Internet that implements network communication by using the TCP/IP protocol. The LAN 4B is constructed as an intranet that uses also the TCP/IP protocol. The LAN 4B is connected to the WAN 4A through a router 5. In some cases, the server units 2A, 2B, . . . of the center server 2 are connected to each other by the WAN 4A instead of the LAN 4B or by the WAN 4A in addition to the LAN 4B. TO the center server 2 and the user terminal apparatus 3, unique IP addresses for identifying them on the network 4 are allocated respectively. In communication in the user terminal apparatuses 3 or between the user terminal apparatus 3 and the center server 2, the IP addresses are used to specify a communication partner. The IP addresses may be so-called dynamic addresses that vary each time they are connected to the network 4, or may be constant static addresses. Hereinafter, information for identifying the center server 2 and the user terminal apparatus 3 on the network 4 will be referred to as address information. In communication through the network 4, unless specifically defined, it is assumed that a communication partner is specified based on the address information.

The center server 2 provides various kinds of Web services to the user terminal apparatus 3 accessing through the network 4. Examples of the Web services include user registration or user verification, a service providing game-play of a predetermined game in response to an access from the user terminal apparatus 3, and a game information service for providing the user with various kinds of information about a game to be executed at the user terminal apparatus 3. In addition, examples of the Web services may include free or non-free distribution of contents which are used in the game such as items, background images, and music, agency of information exchange between users, and the like.

Incidentally, in this type of game system, there are various kinds of methods in a use embodiment of a server, such as a method in which software necessary for game execution is installed into a client apparatus, and the client apparatus accesses the server only in minimum cases requiring server processing such as software update or addition, or online battle; and a method in which the client apparatus is connected to the server in the execution of a game, the server executes arithmetic processing for game progressing, and the client apparatus is in charge of only interface part such as input of operation information by a user and output of game screens and music sounds. The embodiment will continue to be described by taking an example of the case where arithmetic processing of a game based on operation information of a user is executed by the center server 2.

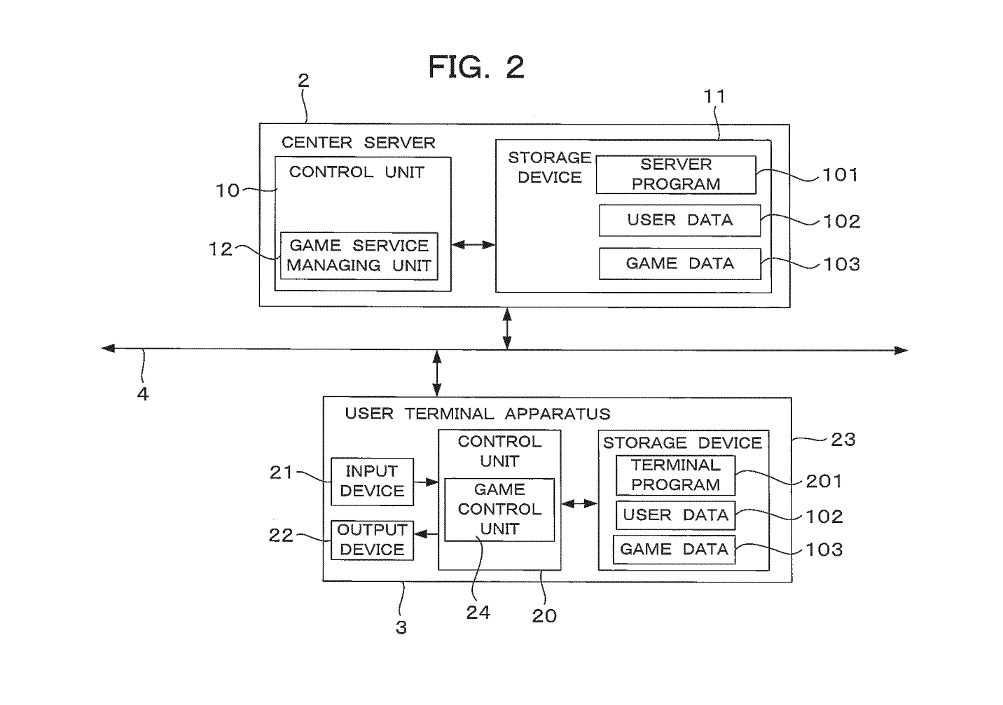

Next, a configuration of a game-related control system of the center server 2 and the user terminal apparatus 3 in the game system 1 will be described with reference to FIG. 2. FIG. 2 is a functional block diagram of a main section of the game system 1.

As illustrated in FIG. 2, the center server 2 includes a control unit 10 and a storage device 11. The control unit 10 is configured as a computer unit by combination of a microprocessor and various kinds of peripheral devices such as an internal storage device (for example, a ROM and a RAM) necessary for operations of the microprocessor. In addition, although not illustrated, an input device such as a keyboard, an output device such as a monitor, and the like are connected to the control unit 10. The storage device 11 is configured by, for example, a mass storage medium such as a magnetic tape such that it can retain storage even without power supply. The storage device 11 stores a server program 101 and various kinds of data that are referred to by the server program 101. As the various kinds of data, game data 103 and user data 102 are stored in the storage device 11. The server program 101 is a computer program that is necessary for the center server 2 to provide various kinds of services to the user terminal apparatus 3.

In the game data 103, game-related information is described, the game-related information being referred to at the moment when a game is provided to a user. In the present embodiment, in order to provide a racehorse training game to the user, in the game data 103, described is, for example, information about a race held during the game, specifically, a racetrack in which the race is conducted, a race distance and the like. Besides the information, in the game data 103, various kinds of data necessary to provide the racehorse training game to the user. In the user data 102, information about each user related to the game (hereinafter, may be referred to as the user information) is described in association with an ID uniquely given to each user (hereinafter, referred to as the user ID). In the user information, for example, a farm name and an owner name to be used in the game, a total amount of prize money earned from the race, information about a racehorse currently owned by the user during the game, and the like are described in association with each other. Each racehorse is set to have characters such as name, sex, racetrack aptitude, and distance aptitude. Further, each racehorse is set to have, for example, a skill as racehorse such as “outstanding last spurt”. In addition, each racehorse is set to have, for example, numerical values of parameters such as level, speed, stamina, and instantaneous force. Further, for example, by getting a racehorse to participate in a race, the numerical values of those parameters can be increased, in other words, can be so-called grown. In addition, each racehorse is set to have state parameters such as information about whether or not the racehorse is in an active state, information about whether or not the racehorse is a breeding horse, information about whether or not the racehorse is a racehorse that has been created by “breeding” (which will be described below), and information about whether or not the racehorse is a racehorse that has been used for breeding. In the user information, such information is described for each racehorse as racehorse information.

When the control unit 10 reads and executes the server program 101, a game service managing unit 12 is provided as a logical device inside the control unit 10. The game service managing unit 12 executes processing necessary to provide a game to a user, such as progressing the game based on information received from the user terminal apparatus 3, and transmitting game result to the user terminal apparatus 3. Further, the game service managing unit 12 executes processing for updating the contents of the user data 102 based on the game result and the information received from the user terminal apparatus 3.

In the user terminal apparatus 3, a control unit 20 is provided. An input device 21, an output device 22, and a storage device 23 are connected to the control unit 20. The control unit 20 is configured as a computer unit by combination of a microprocessor and peripheral devices such as an internal storage device necessary for operation of the microprocessor. The input device 21 is a well-known input device that is operated by the user to input information into the user terminal apparatus 3. For example, in the case of the PC 3a, a keyboard and a mouse are provided as the input devices 21, and in the case of the mobile terminal apparatus 3b, a keyboard and a touch panel are provided as the input devices 21. Further, the input device 21 includes also a camera provided in a portable phone or a smart phone. The output device 22 is a well-known output device that outputs game screens, sounds, or the like to the user. For example, a monitor and a speaker are provided as the output devices 22. The storage device 23 is a storage device capable of storage retention. For example, in the case of the PC 3a, a hard disk storage device is provided as the storage device 23, and in the case of the mobile terminal apparatus 3b, a nonvolatile semiconductor storage device is provided as the storage device 23. The storage device 23 stores a terminal program 201 to be executed in the control unit 20, and the like. Further, the storage device 23 stores at least a part of the game data 103 and user data 102 that has been transmitted from the center server 2 in the execution of the game.

When the control unit 20 reads and executes the terminal program 201 of the storage device 23, a game control unit 24 is provided as a logical device inside the control unit 10. The game control unit 24 executes various kinds of processing, which are necessary to allow the user to play a game, in cooperation with the game service managing unit 12 of the center server 2.

Incidentally, the PC 3a and the mobile terminal apparatus 3b are different in terms of the size of a monitor provided as the output device 22, or the like. Therefore, in the game system 1, a game screen displayed on a monitor of the output device 22 is set to be different between the PC 3a and the mobile terminal apparatus 3b. However, in the PC 3a and the mobile terminal apparatus 3b, an amount of information provided to the user does not vary, and only a display format varies. Incidentally, hereinafter, a description will be given on the assumption that the PC 3a is used as the user terminal apparatus 3.

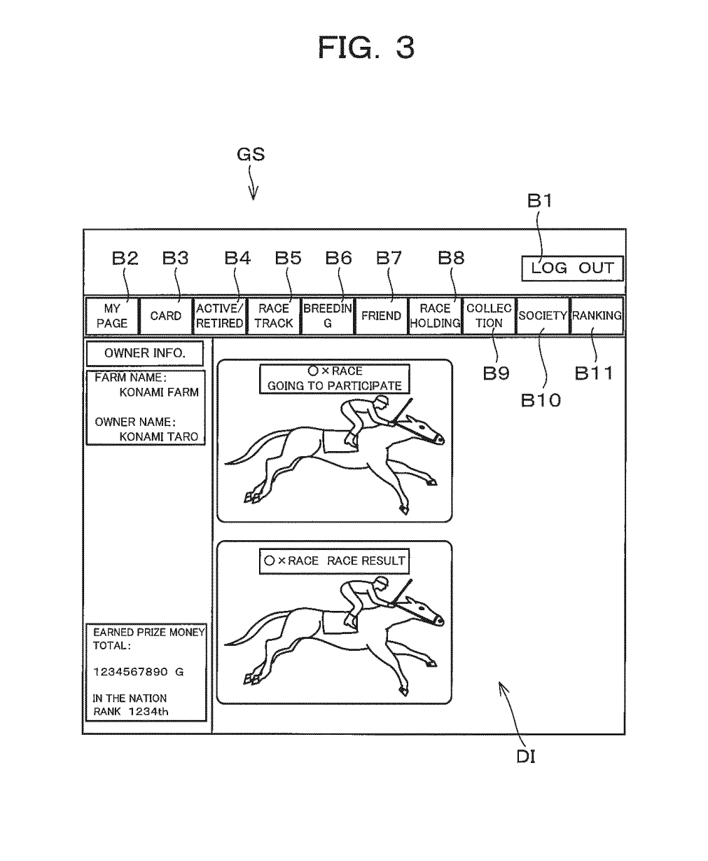

A racehorse training game provided to the user in the game system 1 will be described with reference to FIGS. 3 to 8. In the racehorse training game, the user owns a racehorse and gets the racehorse to participate in a race and grow the racehorse. The user competes with other users for the total amount of prize money earned from the race. Further, the user may own a new racehorse by retiring his own racehorse and making the racehorse into a breeding horse and breeding his own breeding horse with another breeding horse owned by another user. Incidentally, although the user may perform various kinds of other operations on racehorses and other users during the game, their description will be omitted because they are not directly related to the present invention.

Further, in the racehorse training game, the game service managing unit 12 of the center server 2 performs to progress the game, such as holding a race, regardless of whether or not a user is accessing the game system 1. The user logs in the game through the user terminal apparatus 3, and gives various kinds of instructions to his/her own racehorses and the like during the game being progressed by the game service managing unit 12. Herein, the user gives, for example, an instruction for getting a racehorse to participate in a race, or an instruction for retiring a racehorse, as described above. After giving such instruction, the user can log out from the game. The game service managing unit 12 accepts the instruction from the user and progresses the game based on the accepted instruction. Incidentally, results generated by progressing the game, for example, results of the race and the like are saved as the game data 103 in the storage device 11 of the center server 2. The game service managing unit 12 notifies the user of the results, for example, when the user logs in again next time. Based on the notified results, the user further gives an instruction to his/her own racehorses or the like. In this way, the user plays the game.

In the game system 1, the control unit 10 of the center server 2 and the control unit 20 of the user terminal apparatus 3 cooperate to execute the game. More specifically, the game service managing unit 12 of the control unit 10 and the game control unit 24 of each control unit 20 cooperate to execute the game. Further, hereinafter, for simplicity, processing to be executed by the game service managing unit 12 as an actor may be described as processing to be executed by the center server 2, and processing to be executed by the game control unit 24 as an actor may be described as processing to be executed by the user terminal apparatus 3.

FIG. 3 illustrates an example of a game screen GS displayed on the monitor of the user terminal apparatus 3. The game screen GS is displayed when the user logs in the game being progressed by the center server 2 through the user terminal apparatus 3. As illustrated in FIG. 3, a plurality of buttons B1 to B11 to be operated by the user are displayed in an upper portion of the game screen GS. The buttons are operated when the user moves a cursor of the mouse onto any one of the buttons and clicks the mouse in that state. As illustrated in FIG. 3, As the buttons, provided are a “log out” button B1, a “my page” button B2, a “card” button B3, an “active/retired” button B4, a “racetrack” button B5, a “breeding” button B6, a “friend” button B7, a “race holding” button B8, a “collection” button B9, a “society” button B10, and a “ranking” button B11.

User information and game information are displayed in an information display portion DI provided in a lower portion of the game screen GS. As illustrated in FIG. 3, a name of the farm owned by the user during the game, an owner name as user's name during the game, a total amount of prize money earned by the user, a current rank of the user, and the like are displayed in the information display portion DI. Further, results of races in which a racehorse owned by the user has participated, information about a race in which the racehorse will participate, and the like are displayed in the information display portion DI. In addition, although not illustrated, comments from other users and the like may be displayed in the information display portion D1.

Next, a description will be given about processing which is performed when the buttons displayed in the upper portion of the game screen GS are operated. However, within the above mentioned buttons B1 to B11, processing which is performed when any one of the “friend” button B7, the “race holding” button B8, the “collection” button B9, the “society” button B10, and the “ranking” button B11 is operated, is not directly related to the present invention. Therefore, the processing to be performed when these buttons are operated will not be described.

When the “log out” button B1 is operated, log-out information is transmitted from the user terminal apparatus 3 to the center server 2. Then, log-out processing from the game is performed in the center server 2. As the log-out processing, for example, predetermined processing such as updating of the user data 102 by information received lastly from the user terminal apparatus 3 is performed. Thereby, an access to the game of this time is ended. However, the game itself is being progressed by the center server 2 as described above. When the “my page” button B2 is operated, the user terminal apparatus 3 requests the center server 2 to transmit game information and user information, and the center server 2 transmits the game information and the user information to the user terminal apparatus 3. Thereafter, the user terminal apparatus 3 displays the information illustrated in FIG. 3 in the information display portion DI of the game screen GS.

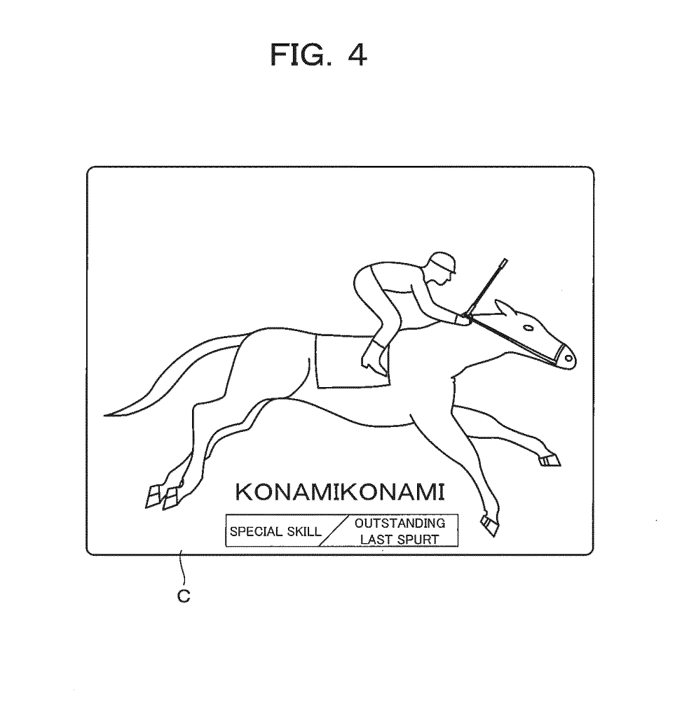

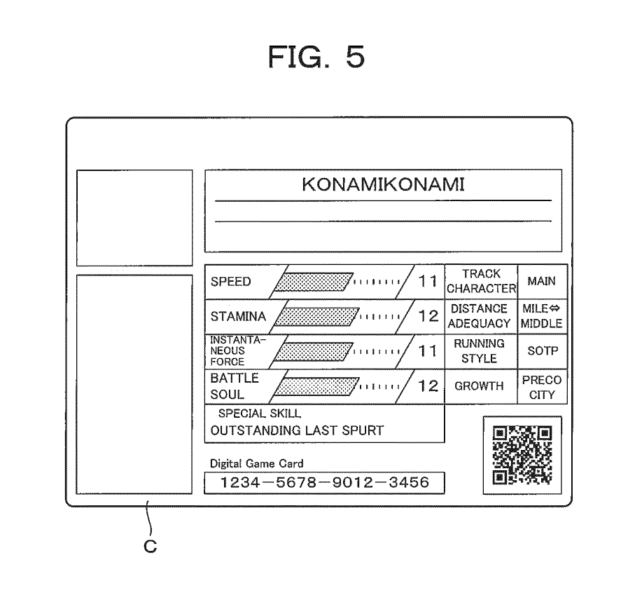

When the “card” button B3 is operated, the user terminal apparatus 3 displays a racehorse registration screen in the information display portion DI. In the racehorse training game, data of a racehorse that can be owned during the game are being sold as a card at stores. FIGS. 4 and 5 illustrate an example of a card C. Incidentally, FIG. 4 illustrates a front surface of the card C, and FIG. 5 illustrates a back surface of the card C. As illustrated in FIG. 4, an image of the racehorse, a name of the racehorse, and a skill possessed by the racehorse are recorded on the surface of the card C. On the other hand, as illustrated in FIG. 5, a name of the racehorse, a character of the racehorse, parameters of the racehorse, and the skill of the racehorse are recorded on the back surface of the card C. Further, a serial code and a two-dimensional barcode for allowing the user to register the racehorse of the card C in the game are recorded on the back surface of the card C. An input portion for inputting the serial code is displayed in the racehorse registration screen. By inputting the serial code into the input portion, the user can register the racehorse of the card C in the game. Incidentally, when the mobile terminal apparatus 3b is used as the user terminal apparatus 3, the user can register the racehorse of the card C in the game by photographing the two-dimensional barcode with a camera of the mobile terminal apparatus 3b. In this way, information of the registered racehorse is transmitted from the user terminal apparatus 3 to the center server 2, so that it is added to the user data 102 as a racehorse which is owned by the user during the game.

When the “active/retired” button B4 is operated, the user terminal apparatus 3 displays a list of racehorses owned by the user in the information display portion DI. Further, the user terminal apparatus 3 displays the “active” button and the “retired” button under each racehorse. The user selects a racehorse to be made into an active state from the list of racehorses, and operates the “active” button of the racehorse. Thereby, the racehorse is registered as an active-state racehorse in a game. In this game, only the racehorse registered as the active-state racehorse can participate in a race. Further, the user may select a racehorse to be made into a retired state from the list of racehorses. In this case, the “retired” button of the racehorse is operated. The racehorse to which the “retired” button is operated, is registered as a breeding horse. Specifically, when the racehorse is a male horse, it is registered as a stallion stud in the game; and when the racehorse is a female horse, it is registered as a brood mare in the game. Information about the racehorse, which has been registered as the active state or the breeding horse, is transmitted from the user terminal apparatus 3 to the center server 2, and racehorse information of the user data 102 is updated. Incidentally, hereinafter, the breeding horse may also be referred to as a retired horse. However, the racehorse that can become the breeding horse is limited to the racehorse that has been is registered by the user who purchased the card C. Therefore, a new racehorse registered by “breeding”, which will be described below, cannot be retired and made into the breeding horse. If the user retires a racehorse generated and registered by the “breeding”, the racehorse is deleted from the game.

When the “racetrack” button B5 is operated, the user terminal apparatus 3 displays a list of active-state racehorses, a list of races which will be held during the game, and a “determination” button in the information display portion DI. Incidentally, the list of racehorses is configured such that the user can select any racehorse by clicking the racehorse with the mouse. Likewise, the list of races is configured such that the user can make a selection with the mouse. The user selects a racehorse to participate in a race, and a race in which the racehorse will participate. Thereafter, when the user operates the “determination” button, the selected racehorse and the selected race are transmitted from the user terminal apparatus 3 to the center server 2, so that participation of the selected racehorse in the selected race is registered. Upon arrival at a predetermined deadline time, the game service managing unit 12 closes participation of each user's racehorse into a race. Thereafter, the game service managing unit 12 performs the race with a predetermined number of racehorses including the racehorse of which the participation has been registered, and saves the race result as game data in the storage device 11.

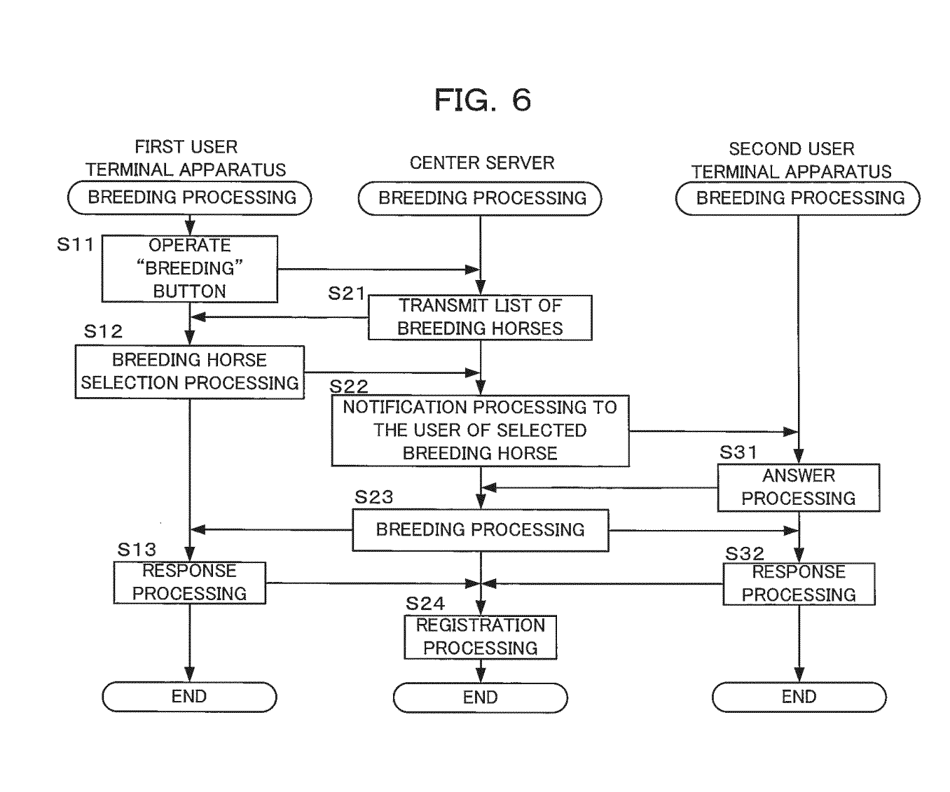

Next, with reference to FIGS. 6 to 8, a description will be given of the case where the “breeding” button B6 is operated. FIG. 6 shows a breeding processing routine that is executed when the “breeding” button B6 is operated. Incidentally, in the racehorse training game, even when one user owns both a stallion stud and a brood mare, the user cannot perform breeding by his/her own breeding horses. Therefore, in order to perform breeding of racehorse, it is necessary to breed with another breeding horse owned by another user. Thus, the user terminal apparatus 3 of the user himself/herself (hereinafter, referred to as the first user terminal apparatus), the user terminal apparatus 3 of another user (hereinafter, referred to as the second user terminal apparatus), and the center server 2 cooperate to implement the routine shown in FIG. 6. This routine is executed when the “breeding” button B6 is operated in the first user terminal apparatus 3.

When this routine is executed, in step S11, the first user terminal apparatus 3 notifies the center server 2 that the “breeding” button B6 is operated. When receiving the notification, in step S21, the center server 2 transmits from the user data 102 stored in the storage device 11, a list of breeding horses of the user of the first user terminal apparatus 3 and a list of breeding horses of the other users to the first user terminal apparatus 3. Incidentally, in this processing, for example, information about a racehorse which has a state parameter set as a breeding horse, within the racehorses owned by each user, may be transmitted.

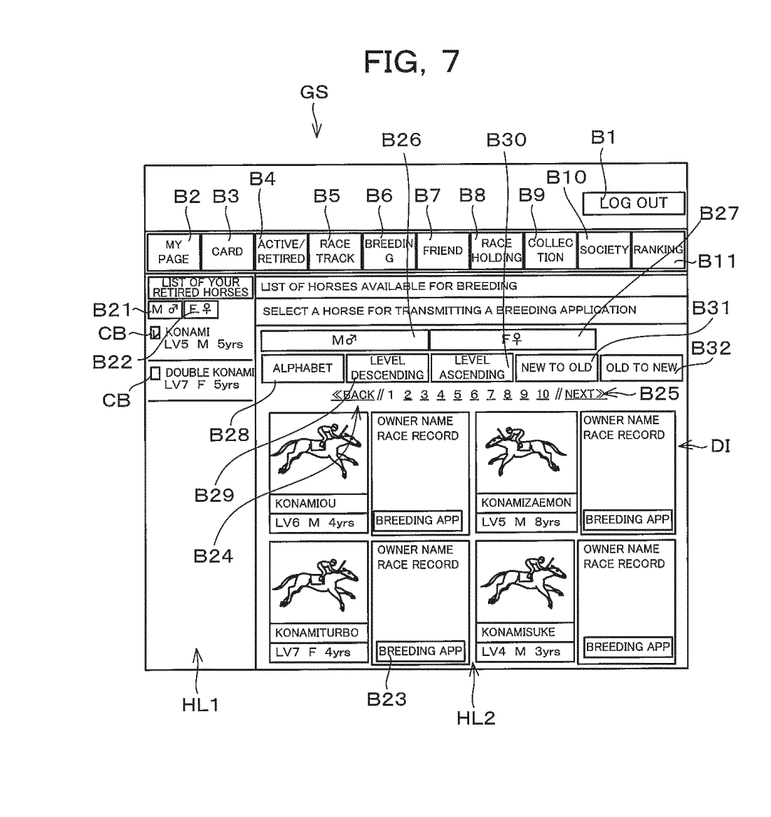

When receiving the list of breeding horses, the first user terminal apparatus 3 executes breeding horse selection processing in step S12. In this breeding horse selection processing, the list of breeding horses is displayed in the information display portion DI of the game screen GS as illustrated in an example of FIG. 7. In this case, the information display portion DI includes an own horse display portion HL1 disposed at a left side thereof and an other users' own horse display portion HL2 disposed at a right side of the own horse display portion HL1. The own horse display portion L1 displays a list of names, levels, sexes, and ages of breeding horses (retired horses) owned by the user himself/herself. Further, a check box CB is displayed at a left side of the name of each breeding horse, and the user can select the breeding horse by clicking the check box CB with the mouse. As illustrated in FIG. 7, the own horse display portion HL1 includes a “male ♂” button B21 and a “female ♀” button B22. When the user operates the “male ♂” button B21, only male horses within the breeding horses owned by the user himself/herself are displayed in the own horse display portion HL1. On the other hand, when the user operates the “female ♀” button B22, only female horses are displayed in the own horse display portion HL1.

The other users' own horse display portion HL2 displays breeding horses owned by the other users. As illustrated in FIG. 7, the display portion HL2 displays a name, level, sex and age of each breeding horse, including an image of the breeding horse. Further, a name and a race record of an owner of the breeding horse are displayed at a right side thereof. This display portion includes a “breeding application” button B23. As illustrated in FIG. 7, a “forward” button B24, a “backward” button B25, and a plurality of numeric buttons displayed therebetween are provided above the portion where the information about breeding horses is displayed in the display portion HL2. When these buttons are operated, information about four breeding horses within the breeding horses other than the breeding horse currently displayed in the display portion HL2 is displayed in the display portion HL2.

Further, as illustrated in FIG. 7, the other users' own horse display portion HL2 additionally includes a “male ♂” button B26, a “female ♀” button B27, an “alphabet” button B28, a “Level Descending” button B29, a “Level Ascending” button B30, a “new to old” button B31, and an “old to new” button B32. Like the “male ♂” button B21 and the “female ♀” button B22 of the own horse display portion HL1, the “male ♂” button B26 and the “female ♀” button B27 are used to extract only male horses or only female horses as the breeding horses to be displayed in the other users' own horse display portion HL2. The “alphabet” button B28, the “Level Descending” button B29, the “Level Ascending” button B30, the “new to old” button B31, and the “old to new” button B32 are used to change the order of breeding horses displayed in the other users' own horse display portion HL2. When the “alphabet” button B28 is operated, the breeding horses are displayed in the alphabet order. When the “Level Descending” button B29 is operated, the breeding horses are displayed in descending order of level. On the other hand, when the “Level Ascending” button B30 is operated, the breeding horses are displayed in ascending order of level. When the “new to old” button B31 is operated, the breeding horses are displayed in descending order of the date of registration as the breeding horse, that is, the data of retirement. On the other hand, when the “old to new” button B32 is operated, the breeding horses are displayed in ascending order of the date of registration as the breeding horse. The user finds a desired breeding horse by operating the buttons B24 to B32.

When the user selects one breeding horse (hereinafter, referred to as the first breeding horse) to be used for breeding from the breeding horses displayed in the own horse display portion HL1 and operates the “breeding application” button B23 of the breeding horse (hereinafter, referred to as the second breeding horse) desired to breed with the first breeding horse within the breeding horses displayed in the other users' own horse display portion HL2, the first user terminal apparatus 3 transmits information about the first breeding horse and the second breeding horse to the center server 2 on the condition that the sex of the first breeding horse is different from the sex of the second breeding horse. Incidentally, when the first breeding horse and the second breeding horse have the same sex, the first user terminal apparatus 3 notifies the user that the breeding is impossible, so that the user selects the first breeding horse and the second breeding horse again.

When receiving the information about the first breeding horse and the second breeding horse, the center server 2 determines a user who owns the second breeding horse based on the information about the second breeding horse, and performs notification processing for transmitting the information about the first breeding horse and the second breeding horse to the user terminal apparatus (second user terminal apparatus) 3 where the user is playing the game and for notifying the user terminal apparatus 3 that a breeding application has been given to the second breeding horse. When receiving the notification, the second user terminal apparatus 3 executes answer processing. In the answer processing, the information about the first breeding horse and the information about the second breeding horse are displayed on the monitor, and it is indicated that the breeding has been applied to the second breeding horse. In addition, buttons for answering whether to accept the application, for example, a “YES” button and a “NO” button are displayed on the monitor. The user owning the second breeding horse operates one of these buttons to answer whether to accept the breeding application. For example, when accepting the breeding application, the user operates the “YES” button; and when declining the breeding application, the user operates the “NO” button. When the user of the second breeding horse operates the “YES” button or the “NO” button, the second user terminal apparatus 3 transmits to the center server 2, information of the operated button, that is, information indicating whether or not the breeding application has been accepted.

When receiving the information indicating whether or not the breeding application has been accepted, the center server 2 executes breeding processing in step S23. Incidentally, in the breeding processing, processing for the case that the application has been declined is also performed. First, a description will be given of the case where the user of the second breeding horse has accepted the breeding application. In this case, the center server 2 generates a new racehorse based on the information about the first breeding horse and the information about the second breeding horse. The parameters and skill of the new racehorse are set based on the parameters and skills of the first breeding horse and the second breeding horse. In this case, a numerical value equivalent to the values of parameters of the breeding horses may be set to each parameter of the new racehorse, or a numerical value higher than the values of parameters of the breeding horses may be set to each parameter of the new racehorse. Thereafter, the center server 2 transmits the information of the parameters and skill of the new racehorse to the first user terminal apparatus 3 and the second user terminal apparatus 3. On the other hand, when the breeding application has been declined, it is announced only to the first user terminal apparatus 3 that the breeding application has been declined.

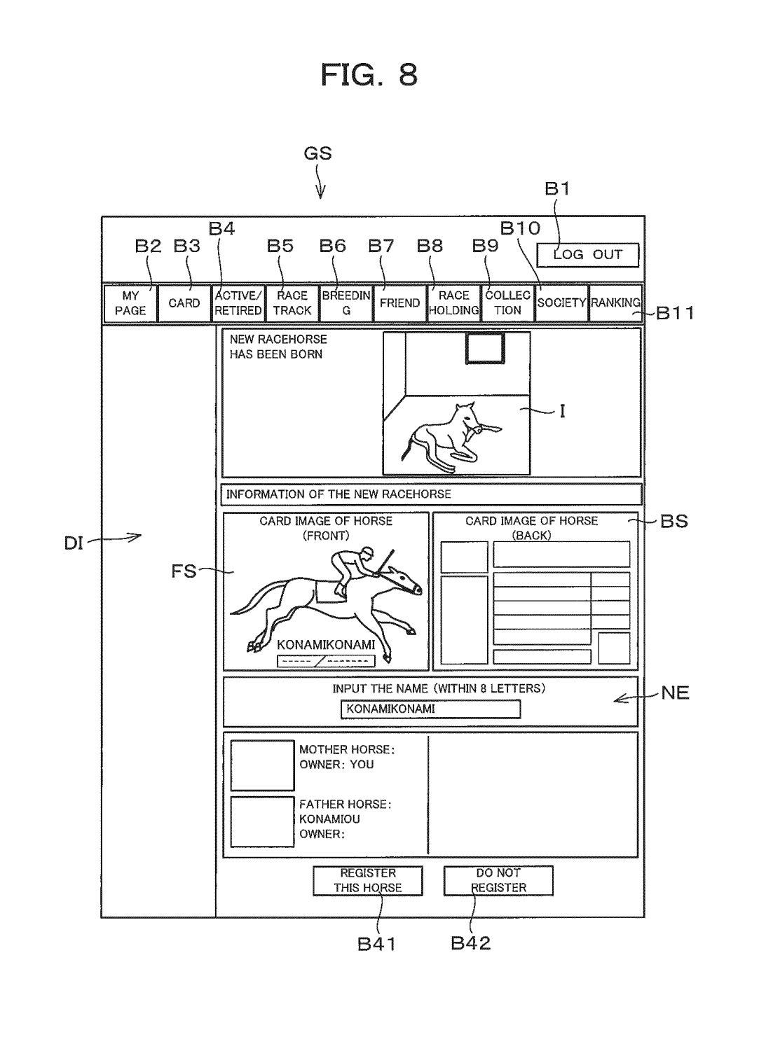

When receiving the information of the new racehorse or the announcement of declination, the first user terminal apparatus 3 executes response processing in step S13. In the response processing, in the case of receiving the announcement of declination, the first user terminal apparatus 3 shows on the monitor that the breeding application has been declined. Thereafter, the first user terminal apparatus 3 ends the routine of this time. On the other hand, when receiving the information of the new racehorse, the first user terminal apparatus 3 displays a breeding success screen on the monitor as illustrated in an example of FIG. 8. As illustrated in FIG. 8, on this screen, in the information display portion DI, an image I indicating that the new racehorse has been born is displayed, and the sex of the new racehorse, numerical values of respective parameters, skills and the like are also displayed in a front surface portion FS and a back surface portion BS in the image of the front surface and back surface of the card C respectively. Further, in the information display portion DI, there is provided a name input portion NE for allowing the user to input the name of the new racehorse. The name input thereinto is used as the name of the new racehorse when the user operates a “register this horse” button B41, which will be described below. In addition, the information display portion DI displays the information about the first breeding horse and the information about the second breeding horse. In addition, the information display portion DI includes the “register this horse” button B41 and a “do not register” button B42. When the “register this horse” button B41 is operated, the first user terminal apparatus 3 transmits to the center server 2, information to be updated with respect to the new racehorse, such as the name given to the new horse, with notification that the new racehorse is to be registered as the racehorse owned by the user. On the other hand, when the “do not register” button B42 is operated, the first user terminal apparatus 3 notifies the center server 2 to stop registering the new racehorse. Thereafter, the routine of this time is ended.

When receiving the information about the new racehorse from the center server 2, the second user terminal apparatus 3 executes response processing in step S32. The processing performed in the response processing is the same as the processing performed when the information about the new racehorse is received in the response processing of step S13. Therefore, the contents of the processing will not be described. Thereafter, the routine of this time is ended.

When receiving the information about the new racehorse and the registration notification, or the registration stop notification from at least one of the first user terminal apparatus 3 and the second user terminal apparatus 3, the center server 2 executes registration processing in step S24. In the registration processing, in a case that the registration stop notification is received, it is stopped that the new racehorse gets registered as a racehorse owned by the user who has transmitted the registration stop notification. On the other hand, in a case that the information about the new racehorse and the registration notification are received, in the registration processing, the information of the new racehorse is updated based on the information of the new racehorse such as the name received from the user terminal apparatus 3, and then the new racehorse is registered as the racehorse owned by the user who has transmitted the registration notification. Specifically, the information of the new racehorse is added to the user data 102 of the user.

Further, when the new racehorse generated by the breeding gets registered, in the registration processing, also performed is processing for the breeding horse of the user which has registered the new racehorse, that is, in a case that the user is the user of the first user terminal apparatus 3, processing for the first breeding horse is also performed. With respect to the breeding horse used in the breeding, in a case that the respective parameters of the breeding horse have been grown by the race or the like, the numerical values of the parameters are initialized, that is, the parameters are returned to the numerical values initially set at the moment of registering the breeding horse with the card C. Further, the racehorse used in the breeding is given a “state parameter indicating that the racehorse was used for the breeding”. Thereafter, the routine of this time is ended.

Incidentally, the “state parameter indicating that the racehorse was used for the breeding” is retained until the registered new racehorse is deleted from the game. While the “state parameter indicating that the racehorse was used for the breeding” is being maintained, the state parameter of the breeding horse is removed. That is, the racehorse becomes unavailable as a breeding horse. Further, it is also impossible to make the racehorse into the active state to participate in a race. When the new racehorse registered is deleted from the game, the “state parameter indicating that the racehorse was used for the breeding” is removed and the state parameter of the breeding horse is given. When returning to this state, it becomes possible to make the breeding horse into the active state to participate in a race. Incidentally, this processing is performed in the center server 2, and the center server 2 functions as a restriction removing unit of the present invention by performing this processing.

As described above, according to the present invention, when breeding of a racehorse is performed, a new racehorse can be generated using a racehorse (breeding horse) owned by another user. Thereby, it is possible to increase the number of breeding horses selectable as a breeding partner. Therefore, under the situation where the information of the newly generated racehorse is determined based on the information of the breeding horses used for the breeding, it is possible to increase a variation in the new racehorse generated by the breeding.

Further, in the present invention, a new breeding horse is generated only when the user of the breeding horse selected as a breeding partner accepts the breeding application. That is, the generation of the new racehorse is performed depending on the intention of each user. Therefore, the user of the breeding horse selected as the breeding partner can decline the breeding. The new racehorse generated by the breeding is provided to each user of each breeding horse used in generating the new racehorse. Therefore, the user owning the second breeding horse can also obtain a privilege which is caused by providing the second breeding horse.

In the present invention, also the breeding horse used in the breeding is not deleted from the game and remains as a racehorse of the user. When the new racehorse generated by the breeding is deleted from the game, the breeding horse used in the breeding can be reused. In this manner, by deleting the new racehorse, even the racehorse used once for the breeding can be used again. Therefore, the user can generate various new racehorses by using the same breeding horse. Accordingly, since the user does not need to own a plurality of same types of breeding horses, it is possible to reduce a burden on the user.

In the present invention, the parameters and skill of the new racehorse are set based on the parameters and skills of the first breeding horse and the second breeding horse. Therefore, it can be seen as if the new racehorse is generated from the first breeding horse and the second breeding horse as parent horses.

In the above-described embodiment, by executing step S12 of FIG. 6, the user terminal apparatus 3 functions as a presenting unit and an accepting unit of the present invention. Further, by executing step S22, the center server 2 functions as an inquiring unit of the present invention. By executing step S23, the center server 2 functions as an item providing unit of the present invention. In the above-described embodiment, the racehorse corresponds to the item of the present invention, and the breeding corresponds to the synchronization of the present invention.

The present invention is not limited to the above-described embodiment, and may be implemented in various embodiments. For example, the game system to which the present invention is applied is not limited to the game system providing the racehorse training game to the user. For example, the present invention may be also applied to a game system providing a monster training game to users, or to a game system providing a role playing game to users. In addition, the present invention may be also applied to various game systems providing a game in which a user can generate a new item by synchronizing a plurality of items. Incidentally, the item in the present invention represents various things that can be owned by the user during the game. For example, in the monster training game, a monster corresponds to the item of the present invention. Further, in the role playing game, arms and defense tools such as swords and shields, and tools such as medical plants correspond to the items of the present invention.

In the above-described embodiment, a user can apply to only one breeding horse of a breeding partner for breeding. However, the number of the breeding horses the user can apply to is not limited to one. For example, in the case that a user selects a stallion stud from the breeding horses owned by the user himself/herself, the system may be configured so that the user can select a plurality of brood mares as breeding partner candidates and gives the breeding application to a plurality of users corresponding to the selected brood mares simultaneously. In a case plural users accepts the breeding application, the system may be configured so that new racehorses are generated from the brood mares of the plural users. Alternatively, the system may be configured so that the user selects one of the plural users who have accepted the breeding application and a new racehorse is generated from the brood mare of the selected user.

In the above-described embodiment, the “state parameter indicating that the racehorse was used for the breeding” is given to the breeding horse, on the condition that the breeding horse is used for the breeding one time. However, the number of times used is not limited to one. For example, the number of times to be used for breeding may be predetermined (for example, ten times), and the “state parameter indicating that the racehorse was used for the breeding” may be given to a breeding horse that reaches the predetermined number of times used for the breeding.

In the above-described embodiment, all breeding horses owned by the other users can be selected as the breeding partner. However, the breeding horses selectable as the breeding partner horse may be limited. For example, in a case that users on good terms with each other are set as friends in the game, the breeding horses selectable as the breeding partner horse may be limited to the breeding horses of the user set as friends. Thereby, an unnecessary increase in the breeding application in the game can be prevented.

In the above-described embodiment, the center server 2 generates the list of breeding horses and a new racehorse by breeding. However, these processes may be performed in the user terminal apparatus 3. In this case, the center server 2 may perform agency of data between the user terminal apparatuses 3 and delivery of data stored in the storage device 11. In this manner, when the user terminal apparatus 3 performs the processes, the access frequency between the center server 2 and the user terminal apparatus 3 can be suppressed to the minimum.

In the game system of the present invention, the terminal program 201 executed in the user terminal apparatus 3 may be browser software that is used to browse a home page of the Internet or the like. In general, the browser software is initially installed in the PC 3a or the mobile terminal apparatus 3b. Therefore, the user does not need to install new software in order to play a game. Accordingly, a burden on the user can be reduced.

### REFERENCE SIGNS LIST

1 Game system
2 Center server (inquiring unit, item providing unit, restriction removing unit)
3 User terminal apparatus (presenting unit, accepting unit)

What is claimed is:

1. A game system that provides a game played by a plurality of users and enables each user to play the game by using items owned by the user in the game and to generate a new item by synchronizing a plurality of items including the items owned by the user, comprising:
a presenting unit which is adapted and configured to present one user within the plurality of users, at least one item within items owned by another user different from the one user, the at least one item being capable of been synthesized with an item owned by the one user;
an accepting unit which is adapted and configured to allow the one user to select a first item which is an item desired by the one user to be synthesized within the items owned by the one user, and a second item which is, within the at least one item presented by the presenting unit, an item desired by the one user to be synthesized with the first item, and accept an input of selection;
an inquiring unit which is adapted and configured to, when the accepting unit accepts the input of selection with respect to the first item and the second item, notify a user owning the second item that there is an application for synthesis which uses the second item from the one user, and make an inquiry about whether to allow the synthesis; and
an item providing unit which is adapted and configured to generate a new item based on the first item and the second item, on the condition that the user owning the second item allows use of the second item for the synthesis in response to the inquiry by the inquiring unit, and provide the new item to the one user.

2. A game system according to claim 1, wherein
the item providing unit is adapted and configured to further provide the new item to the user owing the second item.

3. A game system according to claim 1, wherein,
each of the items in the game has its own information, and
the item providing unit is adapted and configured to generate the new item so that information of the new item include at least one part of information of the first item and information of the second item.

4. A game system according to claim 1, wherein
the item providing unit is adapted and configured to, after presenting the new item to the one user, allow the one user to own the first item with a restriction so as not to use the first item for generating another new item, and
the game system further includes a restriction removing unit which is adapted and configured to remove, in a case that the new item is deleted from the game, the restriction given by the item providing unit so that the first item is available to generate another new item.

5. A control method for controlling a computer incorporated into a game system that provides a game played by a plurality of users and enables each user to play the game by using items owned by the user in the game and to generate a new item by synchronizing a plurality of items including the items owned by the user, the control method making the computer execute the steps including:
a presenting step of presenting one user within the plurality of users, at least one item within items owned by another user different from the one user, the at least one item being capable of been synthesized with an item owned by the one user;
an accepting step of allowing the one user to select a first item which is an item desired by the one user to be synthesized within the items owned by the one user, and a second item which is, within the at least one item presented by the presenting step, an item desired by the one user to be synthesized with the first item, and accepting an input of selection;
an inquiring step of, when the input of selection with respect to the first item and the second item being accepted by the accepting step, notifying a user owning the second item that there is an application for synthesis which uses the second item from the one user, and making an inquiry about whether to allow the synthesis; and
an item providing step of generating a new item based on the first item and the second item, on the condition that the user owning the second item allows use of the second item for the synthesis in response to the inquiry by the inquiring step, and providing the new item to the one user.

6. A non-transitory computer readable medium storing a computer program for a game system that provides a game played by a plurality of users and enables each user to play the game by using items owned by the user in the game and to generate a new item by synchronizing a plurality of items including the items owned by the user, the computer program making a computer incorporated into the game system function as:
a presenting unit which is adapted and configured to present one user within the plurality of users, at least one item within items owned by another user different from the one user, the at least one item being capable of been synthesized with an item owned by the one user;
an accepting unit which is adapted and configured to allow the one user to select a first item which is an item desired by the one user to be synthesized within the items owned by the one user, and a second item which is, within the at least one item presented by the presenting unit, an item desired by the one user to be synthesized with the first item, and accept an input of selection;
an inquiring unit which is adapted and configured to, when the accepting unit accepts the input of selection with respect to the first item and the second item, notify a user owning the second item that there is an application for synthesis which uses the second item from the one user, and make an inquiry about whether to allow the synthesis; and
an item providing unit which is adapted and configured to generate a new item based on the first item and the second item, on the condition that the user owning the second item allows use of the second item for the synthesis in response to the inquiry by the inquiring unit, and provide the new item to the one user.
